(19) United States
(12) Patent Application Publication
(10) Pub. No.: US 2008/0105517 A1
(43) Pub. Date: May 8, 2008

(54) Spliceless, corded baler belt

(76) Inventors: Donald Ray Belik, Lincoln, NE (US); William Leon Ziegelbein, Lincoln, NE (US); Wesley James Billups, Marysville, OH (US)

Correspondence Address: WOOD, HERRON & EVANS, LLP, 2700 CAREW TOWER, 441 VINE STREET, CINCINNATI, OH, 45202, US

(21) Appl. No.: 11/594,382

(22) Filed: Nov. 8, 2006

(51) Int. Cl. B65G 15/32; B31F 5/00

(52) U.S. Cl. 198/844.2; 156/159

(57) ABSTRACT

An endless elastomeric baler belt is comprised of one or more fabric reinforcement layers, and one or more elastomeric layers, and further comprises a reinforcement layer formed of cord or a rubberized strip of one or more cords that are spirally wound in an endless configuration forming a helix. The width of the spiral reinforcement layer is preferably less than the width of the belt.

### FIELD OF THE INVENTION

The invention relates to belts, and more particularly to belts for use in a baler machine.

### BACKGROUND OF THE INVENTION

Crop baling machines, or balers, typically utilize a moving elongated elastomeric belt to manipulate the crop in one or more ways. In the context of a round hay baler, one or more such elastomeric belts pass over and under a series of drive, idler, and tensioner rollers in a serpentine like arrangement. The belts function to take and form an incoming row of crop into a spiral roll of increasing diameter.

One problem with baler belts is that they typically are made of fabric plies, typically two plies, wherein the ends of the belt are spliced together. FIG. 1 illustrates how the belt ends are spliced together, typically using metal eyelets or hooks 303 with a rod 304 passing through the eyelets. The splice can be a source of structural weakness in the belt. Eventually, as the belt wears in service, the belt eventually will fail at the splice. Thus an improved endless belt is desired which eliminates the splice, is desired.

### SUMMARY OF THE INVENTION

An endless elastomeric baler belt is comprised of one or more fabric reinforcement layers, and one or more elastomeric layers, and further comprises a reinforcement layer formed of cord that is spirally wound in an endless configuration forming a helix. The width of the spiral reinforcement layer is preferably less than the width of the belt.

### BRIEF DESCRIPTION OF THE DRAWINGS

The invention will be described by way of example and with reference to the accompanying drawings in which:

FIG. 1 is a perspective view of a prior art baler belt splice commonly used on belting in agricultural applications;

FIG. 2 is a perspective view of a baler belt of the present invention; and

FIG. 3 is a cross-sectional view of the baler belt of FIG. 1;

FIG. 4 is a further illustration of the belt being built on a mandrel.

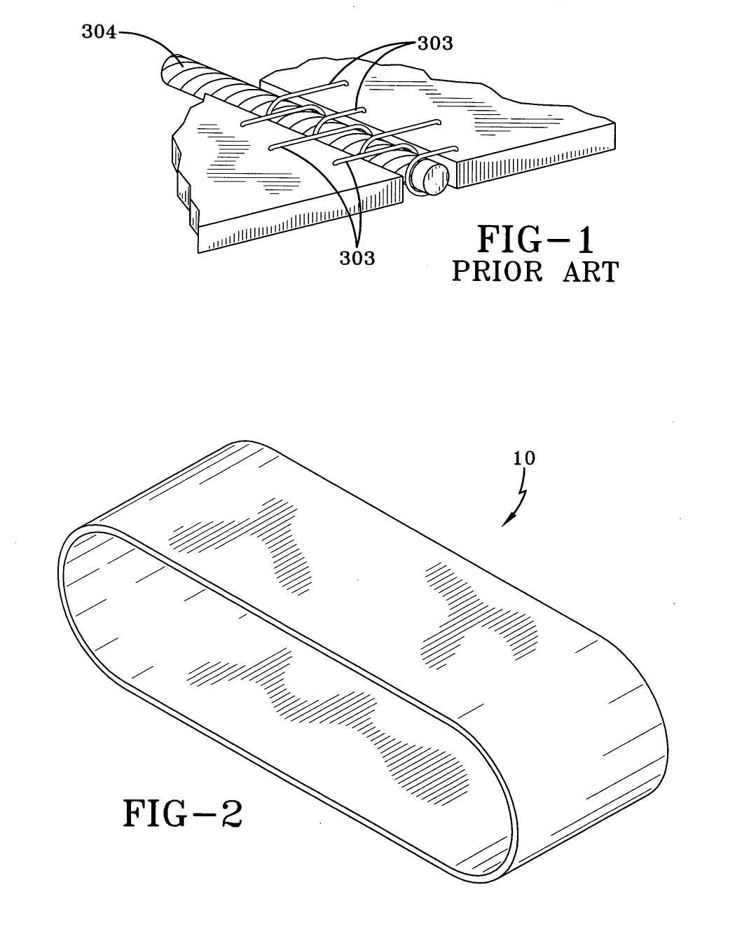

### DETAILED DESCRIPTION OF THE INVENTION

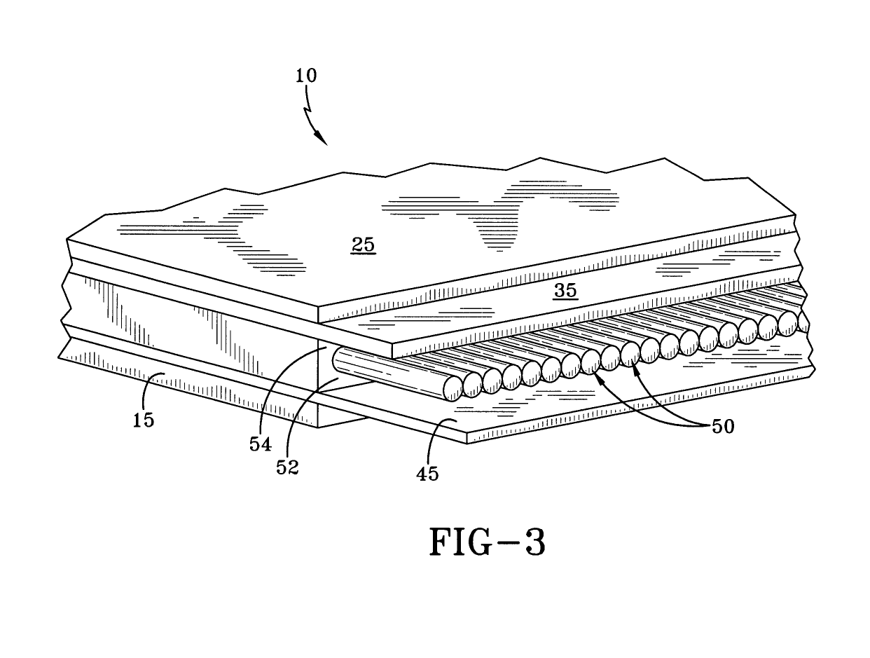

FIG. 2 illustrates an endless belt 10 of the invention, suitable for use as, for example, a baler belt. As shown in FIG. 3, the endless belt 10 comprises an elastomeric body 10 that may be a unitary structure or may include a first skim layer 15 and a second skim layer 25 which are substantially parallel and composed of the same or different elastomeric and resilient materials. Representative of the elastomeric materials which may be used include thermosetting natural or synthetic rubbers, thermoplastic elastomers and urethanes.

Located adjacent each first and second skim layer 15, 25 is a first and second layer of fabric reinforcement 35, 45. The endless belt 10 may comprise an additional fabric reinforcement layer 50 comprised of cords. The cords may be formed of any suitable material such as, but not limited to, nylon, nylon 6, 6, aramid, polyester, natural fiber or combinations thereof. The cords are preferably dipped in adhesive prior to being incorporated into elastomer to ensure bonding of the fiber to the elastomer. The selected adhesive is determined so as to be compatible with the fiber being used and to permit the fiber to remain bonded to the elastomer during curing and use of the belt. The cord layer 50 may be formed by spirally winding the cord around the mandrel to form a continuous, endless helix. The cords may or may not be overlapped. The cords may also be spaced apart a desired amount. The angle of the helix is within about 10 degrees or less relative to the circumferential direction, and depends on the cord width. The endless reinforcement layer is shown in FIG. 3. Gum layers 52, 54 surround the layer of cord 50 and are located between reinforcement layers 45, 55. Because the reinforcement layer 50 is endless, the belt has the strength of a spliceless belt.

The fabric reinforcement layers 35, 45, 55 may comprise any suitable material known to those skilled in the art such as polyester, nylon, kevlar or aramid and rayon.

Alternatively, the cord reinforcement layer 50 may be formed of a strip of one or more cords (not shown) embedded in an unvulcanized elastomer such as rubber. The cord layer 50 may be formed by spirally winding the rubberized strip around the mandrel to form a continuous, endless helix. The strips may or may not be overlapped or spaced apart a desired amount. The angle of the helix is within about 10 degrees or less relative to the circumferential direction, and depends on the strip width. The strips may be any desired width, for example, 0.5 inch, 1 inch, 2 inch.

Preferably, the cord or strip is applied to the mandrel in a “jump lay” manner, i.e., inside of the cut line of the belt. Thus the width of the reinforcement layer 50 is less than the width of the belt. If multiple belts are being built on the mandrel, the jump lay is performed at every belt width. Thus each belt has cut ends of the cord at the lateral ends. The ends are tucked inside the fabric layers of the belt prior to cure.

After the desired number of layers of elastomer and reinforcement is applied to the mandrel, the belts are cut to the desired width and removed from the mandrel. The belts are then subjected to heat and pressure to cure the elastomer.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An endless elastomeric baler belt comprised of one or more fabric reinforcement layers, and one or more elastomeric layers, and further comprising a reinforcement layer formed of cord that is spirally wound in an endless configuration forming a helix.

2. The endless belt of claim 1 wherein the width of the spiral reinforcement layer is less than the width of the belt.

3. A method of making an endless elastomeric baler belt, the method comprising the steps of providing a mandrel, applying a first layer of elastomer to the mandrel, splicing the ends of the first layer together, applying a fabric reinforcement layer over said first layer and splicing the ends of the fabric reinforcement layer together, forming a third reinforcement layer over the second layer by spirally winding a reinforcement member forming an endless helix.

4. The method of claim 3 wherein the reinforcement member is cord.

5. The method of claim 3 wherein the reinforcement member is a rubberized strip formed of two or more cords.
